(19) United States
(12) Patent Application Publication
(10) Pub. No.: US 2019/0204013 A1
(43) Pub. Date: Jul. 4, 2019

(54) Devices for Flowing Fluids Therethrough, and Methods for Manufacturing Thereof

(71) Applicant: Innovative Weld Solutions Ltd., Dayton, OH (US)

(72) Inventor: Venkatasubramanian Ananthanarayanan, Beavercreek, OH (US)

(73) Assignee: Innovative Weld Solutions Ltd., Dayton, OH (US)

(21) Appl. No.: 15/857,989

(22) Filed: Dec. 29, 2017

(51) Int. Cl. F28D 15/00; B23P 15/26; B21J 15/08

(52) U.S. Cl. CPC F28D 15/00; B21J 15/08; B23P 15/26

(57) ABSTRACT

A device for flowing fluids therethrough, the device including: a first structure having a first major side, said first structure comprising a first metal composition; a second structure having a second major side abutting said first major side, said second structure comprising a second metal composition; at least one welded region affixing said first major side of said first structure with said second major side of said second structure; at least one fluid channel defined at an unwelded interface of said first major side of said first structure and said second major side of said second structure; and at least one sealing member compressed between said first major side of said first substrate and said second major side of said second substrate, said at least one sealing member comprising a material having a lower hardness than that of said first metal composition and said second metal composition.

### FIELD

The present description relates to devices for flowing fluids therethrough and, in particular, devices having a first structure bonded to a second structure with at least one fluid channel at an interface thereof.

### BACKGROUND

In the related art, there are devices for flowing fluids therethrough, in which the devices include a first structure bonded to a second structure with a plurality of fluid channels at an interface thereof, in which the first structure and second structure are joined by electron beam welding or brazing. However, electron beam welding is typically suitable for joining first and second structures having comparable chemistries, and brazing is typically suitable for joining first and second structures having melting points significantly above that of the brazing material. Additionally, devices joined by electron beam welding or brazing have a problem with a failure to preserve an intended structure of the fluid channels. For example, during the joining process, a fluid channel may become partially or fully blocked and/or a barrier between adjacent fluid channels may breakdown to unintentionally connect adjacent fluid channels.

Accordingly, those skilled in the art continue with research and development in the field of devices for flowing fluids therethrough and methods for manufacturing thereof.

### SUMMARY

In one embodiment, a device for flowing fluids therethrough includes: a first structure having a first major side, said first structure comprising a first metal composition; a second structure having a second major side abutting said first major side of said first structure, said second structure comprising a second metal composition; at least one welded region affixing said first major side of said first structure with said second major side of said second structure; at least one fluid channel defined at an unwelded interface of said first major side of said first structure and said second major side of said second structure; and at least one sealing member compressed between said first major side of said first substrate and said second major side of said second substrate, said at least one sealing member comprising a material having a lower hardness than that of said first metal composition and said second metal composition.

In another embodiment, a device for flowing fluids therethrough includes: a first structure having a first major side, said first structure comprising a first metal composition; a second structure having a second major side abutting said first major side, said second structure comprising a second metal composition different from said first metal composition; a plurality of welded regions affixing said first major side of said first structure with said second major side of said second structure; a plurality of fluid channels defined at unwelded interfaces of said first major side of said first structure and said second major side of said second structure; and at least one sealing member compressed between said first major side of said first substrate and said second major side of said second substrate, said at least one sealing member sealing between adjacent fluid channels, said at least one sealing member comprising a third metal composition having a lower hardness than that of said first metal composition and said second metal composition.

In yet another embodiment, a method for manufacturing a device for flowing fluids therethrough includes: providing a first structure having a first major side, said first major side defining a first portion of a plurality of fluid channels; providing a second structure having a second major side, said second major side defining a second portion of said plurality of fluid channels; and affixing said first major side of said first structure with said second major side of said second structure by at least one interference pin weld.

In yet another embodiment, a device for flowing fluids therethrough, the device includes: a first structure having a first major side, said first structure comprising a first metal composition; a second structure having a second major side abutting said first major side of said first structure, said second structure comprising a second metal composition; at least one brazed region affixing said first major side of said first structure with said second major side of said second structure, wherein one of said first major side of said first structure and said second major side of said second structure comprises a pin, the other of said first major side of said first structure and said second major side of said second structure comprises a recess, and said at least one brazed region affixes said pin with said recess; and at least one sealing member compressed between said first major side of said first substrate and said second major side of said second substrate, said at least one sealing member comprising a material having a lower hardness than that of said first metal composition and said second metal composition.

Other embodiments of the disclosed devices for flowing fluids therethrough and methods for manufacturing thereof will become apparent from the following detailed description, the accompanying drawings and the appended claims.

### BRIEF DESCRIPTION OF THE DRAWINGS

FIG. 1 is an exploded top perspective view of an exemplary device for flowing fluids therethrough;

FIG. 2 is a bottom perspective view of the device of FIG. 1;

FIG. 3 is a perspective view of the device of FIG. 1 after bonding;

FIG. 4 is a sectional view of the device of FIG. 3 along sectional line 4-4;

FIG. 5 is another section view of the device of FIG. 3 along sectional line 5-5;

FIG. 6 is an exploded top perspective view of another exemplary device for flowing fluids therethrough;

FIG. 7 is a bottom perspective view of the device of FIG. 6;

FIG. 8 is a perspective view of the device of FIG. 6 after bonding;

FIG. 9 is a sectional view of the device of FIG. 8 along sectional line 9-9;

FIG. 10 is an exploded top perspective view of yet another exemplary device for flowing fluids therethrough;

FIG. 11 is a top plan view of a structure of the device of FIG. 10;

FIG. 12 a sectional side view of the structure of FIG. 11 along line 12-12;

FIG. 13 is a perspective view of a structure of FIG. 10;

FIG. 14 is a perspective view of the device of FIG. 10 after bonding;

FIG. 15 is a sectional perspective view an exemplary interference pin welding process before welding;

FIG. 16 is a sectional side view the exemplary interference pin welding process before welding of FIG. 15;

FIG. 17 is a sectional view of the exemplary interference pin welding process of FIGS. 15 and 16 after welding;

FIG. 18 is a sectional perspective view another exemplary interference pin welding process before welding;

FIG. 19 is a sectional side view the exemplary interference pin welding process before welding of FIG. 18; and

FIG. 20 is a sectional view of the exemplary interference pin welding process of FIGS. 18 and 19 after welding.

### DETAILED DESCRIPTION

The present description relates to devices for flowing fluids therethrough having a first structure bonded by welding or brazing, e.g., furnace brazing or resistance brazing, to a second structure with at least one fluid channel at an interface thereof, and methods for manufacturing thereof. It will be understood that following detailed description discloses the invention with reference to bonding the first structure to the second structure by welding, but the invention is equally applicable to bonding the first structure to the second structure by brazing.

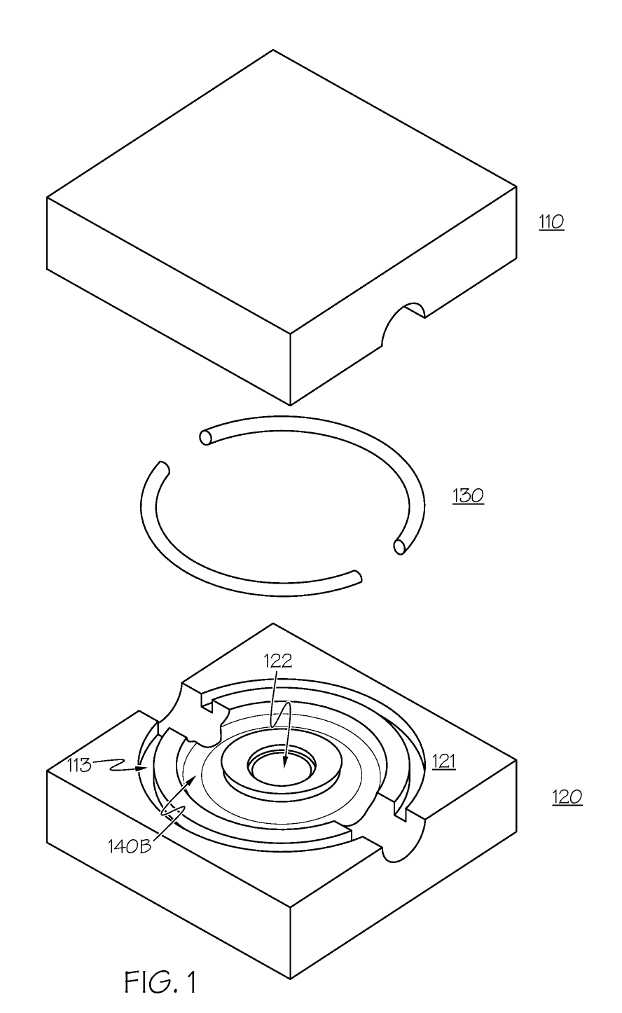

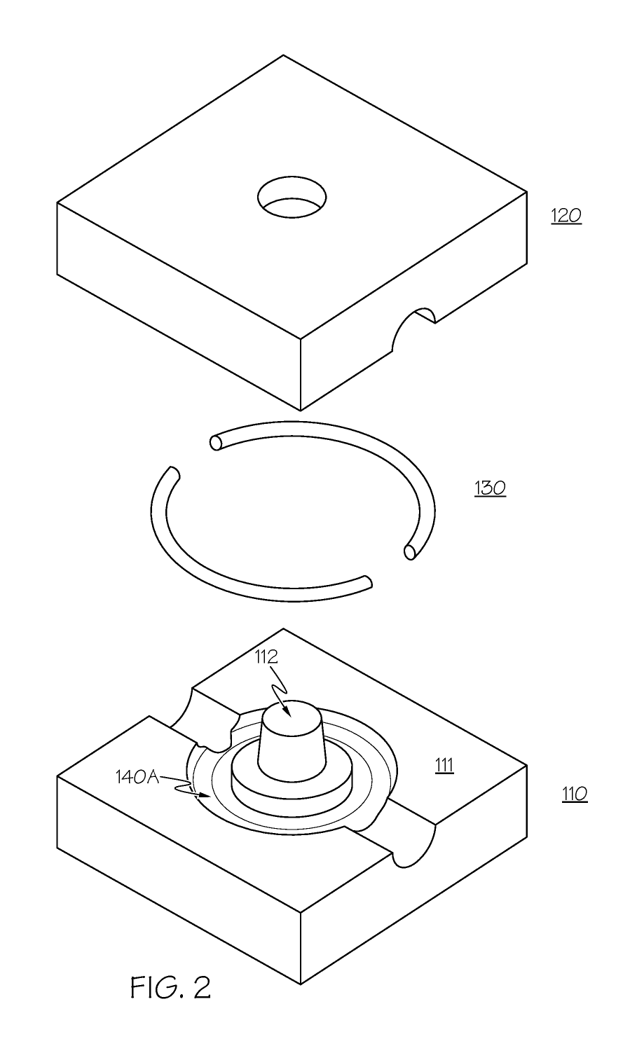

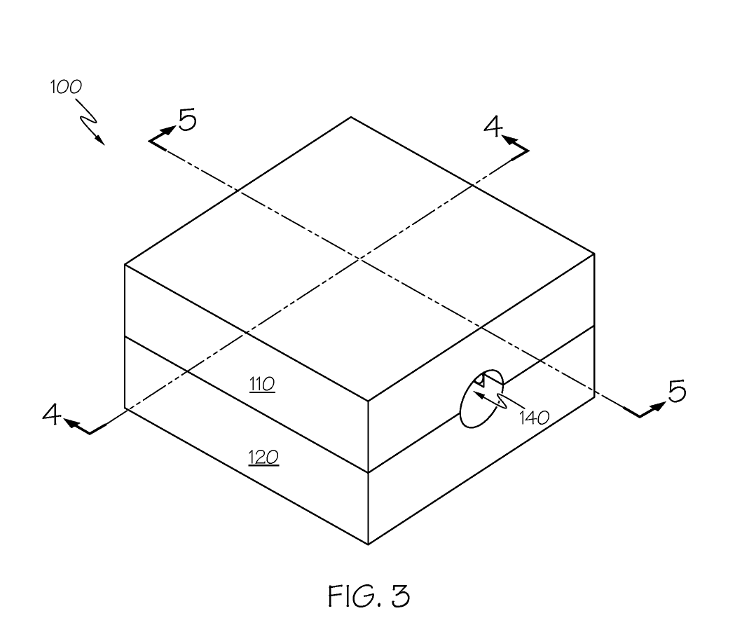

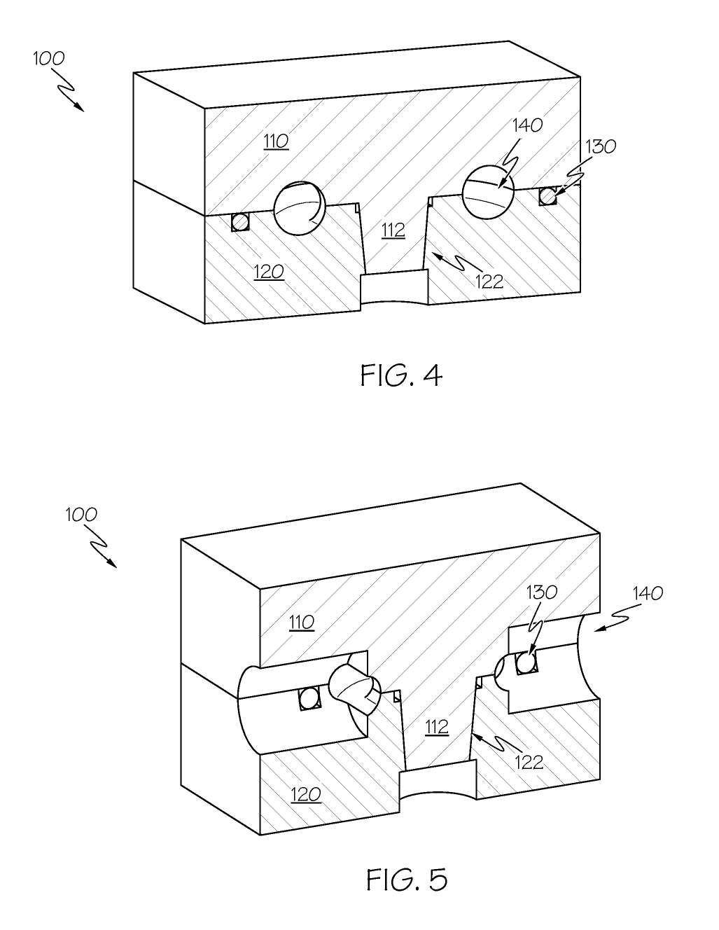

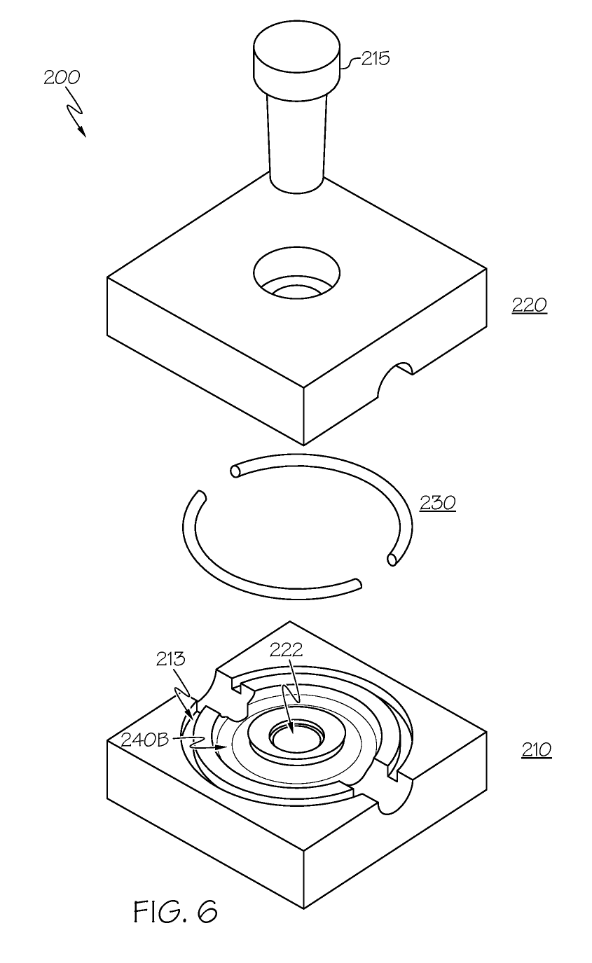

FIG. 1 illustrates an exploded top perspective view of a device 100 for flowing fluids therethrough, including a first structure 110, a second structure 120, and a sealing member 130. FIG. 2 illustrates bottom perspective view of the device of FIG. 1. FIG. 3 illustrates the first structure 110, the second structure 120, and the sealing member 130 after bonding the first structure 110 and the second structure 120. FIG. 4 illustrates the device 100 of FIG. 3 along sectional line 4-4. FIG. 5 illustrates the device 100 of FIG. 3 along sectional line 5-5.

As shown by FIGS. 1 and 2, the device 100 for flowing fluids therethrough includes the first structure 110 having a first major side 111, the second structure 120 having a second major side 121, and the sealing member 130.

The first major side 111 of the first structure 110 and the second major side 121 of the second structure 120 together define fluid channel surfaces 140A and 140B at an interface of said first major side 111 and said second major side 121 for flowing fluids through a fluid channel of the device.

As further shown by FIGS. 1 and 2, the first major side 111 of the first structure 110 includes a welding pin 112, and the second major side 121 of the second structure 120 includes a welding recess 122. It will be understood that the positions of the welding pin 112 and welding recess 122 may be reversed, such that the second major side 121 of the second structure 120 includes the welding pin 112, and the first major side 111 of the first structure 110 includes the welding recess 122.

As shown by FIGS. 3-5, the first structure 110 and second structure 120 are bonded together by an interference pin weld between the welding pin 112 and the welding recess 122 creating a metallurgical bond affixing together the first structure 110 and the second structure 120 localized at the connection of the welding pin 112 and welding recess 122. Due to localized welding of the first structure 110 and the second structure 120, other portions of the first major side 111 and second major side 121 remain unmelted. Therefore, the fluid channel 140 formed at the interface of the first major side 111 and the second major side 121 are not affected by the welding process. Therefore, the structure of the fluid channel 140 is preserved during the bonding of the first structure 110 and the second structure 120, and the fluid channel 140 does not may become partially or fully blocked due to melting and adjacent fluid channels do not become connected due to a breakdown of a barrier therebetween. This preservation of the structure of the fluid channel 140 permits for smaller fluid channels and concentration of multiple adjacent fluid channels with reduced concern that the process of bonding together the first structure and the second structure will unintentionally block a fluid channel or break down a barrier between adjacent fluid channels.

Moreover, the first structure may be formed from a first metal composition, and the second structure may be formed from a second metal composition different from said first metal composition.

Furthermore, as illustrated in FIGS. 1-5, the device 100 provides for sealing of the fluid channel or sealing between adjacent fluid channels. In particular, as shown by FIGS. 1, 4 and 5, the first major side 111 of the first structure 110 includes a sealing channel 113 for retaining sealing member 130 therein.

As illustrated, the sealing channel 113 is positioned along one side of the fluid channel 140. However, sealing channel 113 can be arranged in any number of positions to provide a desired sealing effect.

Additionally, it will be understood that the position of sealing channel 113 may be reversed, such the second major side 121 of the second structure 120 includes the sealing channel 113.

The sealing member 130 is formed of a material that is softer than that of the first structure 110 and the second structure 120. Preferably, the sealing member 130 is formed of a metal that is softer (i.e. lower hardness) than that of the first structure 110 and the second structure 120. When the first structure 110 and second structure 120 are bonded together, the sealing member 130 is compressed therebetween to thereby seal the fluid channel 140 or seal between adjacent fluid channels 140.

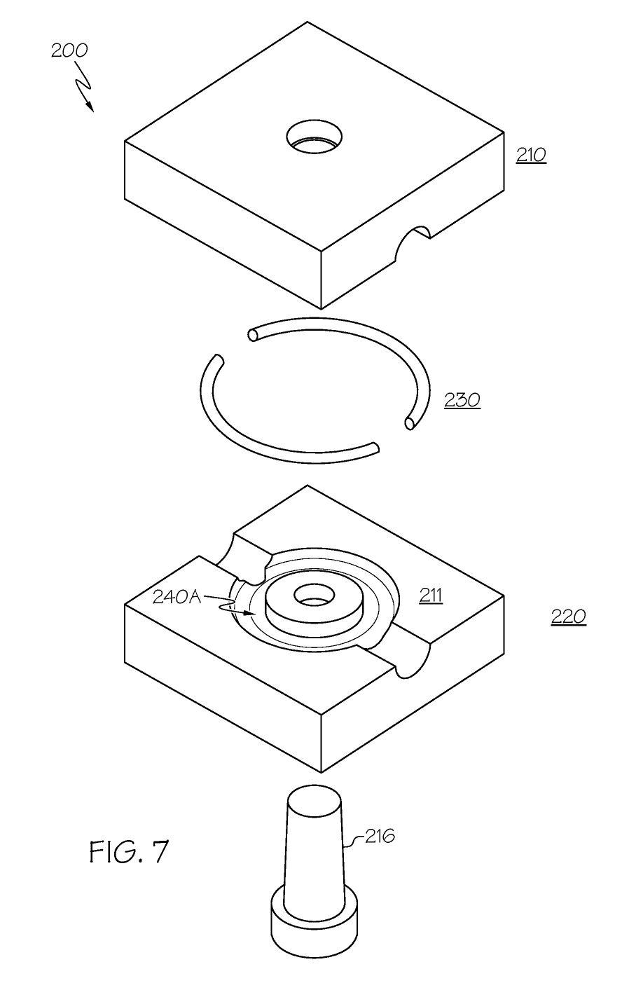

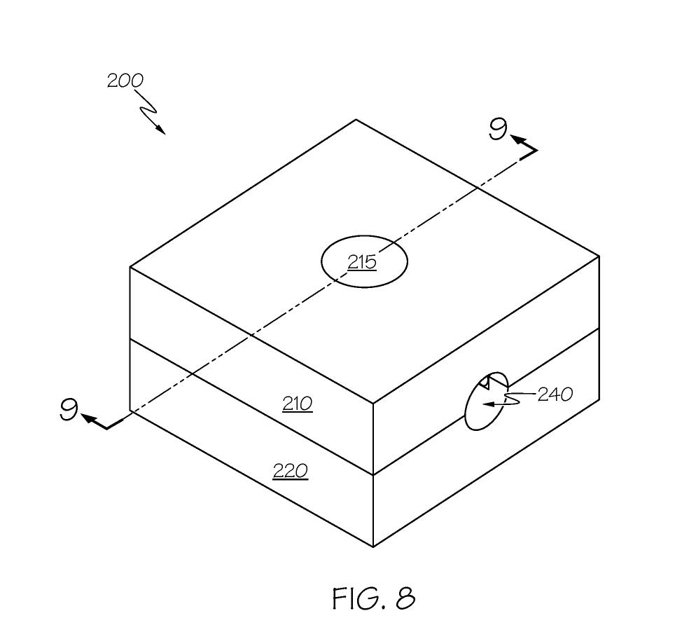

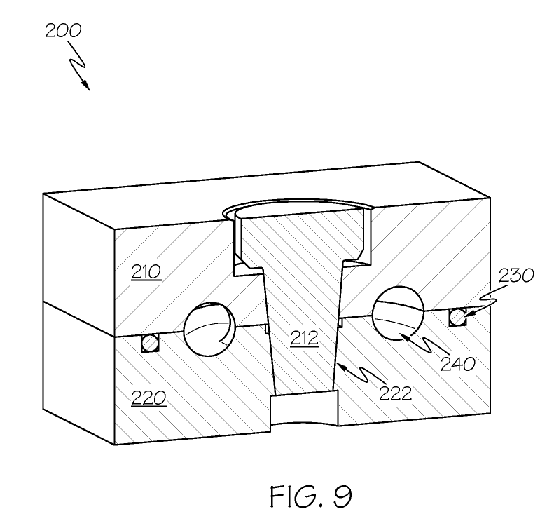

FIG. 6 illustrates an exploded top perspective view of a device 200 for flowing fluids therethrough, including a first structure 210, a second structure 220, a welding rivet 215, and a sealing member 230. FIG. 7 illustrates bottom perspective view of the device of FIG. 6. FIG. 8 illustrates the first structure 210, the second structure 220, the welding pin 215, and the sealing member 230 after bonding the first structure 210 and the second structure 220. FIG. 9 illustrates the device 200 of FIG. 8 along sectional line 9-9.

As shown by FIGS. 6 and 7, the device 200 for flowing fluids therethrough includes the first structure 210 having a first major side 211, the second structure 220 having a second major side 221, the welding rivet 215, and the sealing member 230.

The first major side 211 of the first structure 210 and the second major side 221 of the second structure 220 together define fluid channel surfaces 240A and 240B at an interface of said first major side 211 and said second major side 221 for flowing fluids through a fluid channel of the device.

As further shown by FIGS. 6 and 7, the first major side 211 of the first structure 210 includes a welding recess 216, and the second major side 221 of the second structure 220 includes a welding recess 222. It will be understood that the positions of the welding recess 216 and welding recess 222 may be reversed, such that the second major side 221 of the second structure 220 includes the welding recess 216, and the first major side 211 of the first structure 210 includes the welding recess 222.

As shown by FIGS. 8 and 9, the first structure 210 and second structure 220 are bonded together by welds between the welding rivet 215, the welding recess 216, and the welding recess 222, creating a metallurgical bond affixing together the first structure 210 and the second structure 220 localized at the connection of the welding rivet 215, the welding recess 216, and the welding recess 222. Due to localized welding of the first structure 210 and the second structure 220, other portions of the first major side 211 and second major side 221 remain unmelted. Therefore, the fluid channel 240 formed at the interface of the first major side 211 and the second major side 221 are not affected by the welding process. Therefore, the structure of the fluid channel 240 is preserved during the bonding of the first structure 210 and the second structure 220, and the fluid channel 240 does not may become partially or fully blocked due to melting and adjacent fluid channels do not become connected due to a breakdown of a barrier therebetween. This preservation of the structure of the fluid channel 240 permits for smaller fluid channels and concentration of multiple adjacent fluid channels with reduced concern that the process of bonding together the first structure and the second structure will unintentionally block a fluid channel or break down a barrier between adjacent fluid channels.

Moreover, the first structure may be formed from a first metal composition, the second structure may be formed from a second metal composition different from said first metal composition, and the welding rivet may be formed from a third metal composition different than that of the first metal composition and second metal composition. Thus, due to the absence of welding between the first metal composition of the first structure and the second metal composition of the second structure, the first metal composition and second metal composition may be selected from chemistries that are incompatible for welding with each other.

Furthermore, as illustrated in FIGS. 6-9 the device 200 provides for sealing of the fluid channel or sealing between adjacent fluid channels. In particular, as shown by FIGS. 6 and 9, the first major side 211 of the first structure 210 includes a sealing channel 213 for retaining sealing member 230 therein.

As illustrated, the sealing channel 213 is positioned along one side of the fluid channel 240. However, sealing channel 213 can be arranged in any number of positions to provide a desired sealing effect.

Additionally, it will be understood that the position of sealing channel 213 may be reversed, such the second major side 221 of the second structure 220 includes the sealing channel 213.

The sealing member 230 is formed of a material that is softer than that of the first structure 210 and the second structure 220. Preferably, the sealing member 230 is formed of a metal that is softer (i.e. lower hardness) than that of the first structure 210 and the second structure 220. When the first structure 210 and second structure 220 are bonded together, the sealing member 230 is compressed therebetween to thereby seal the fluid channel 240 or seal between adjacent fluid channels 240.

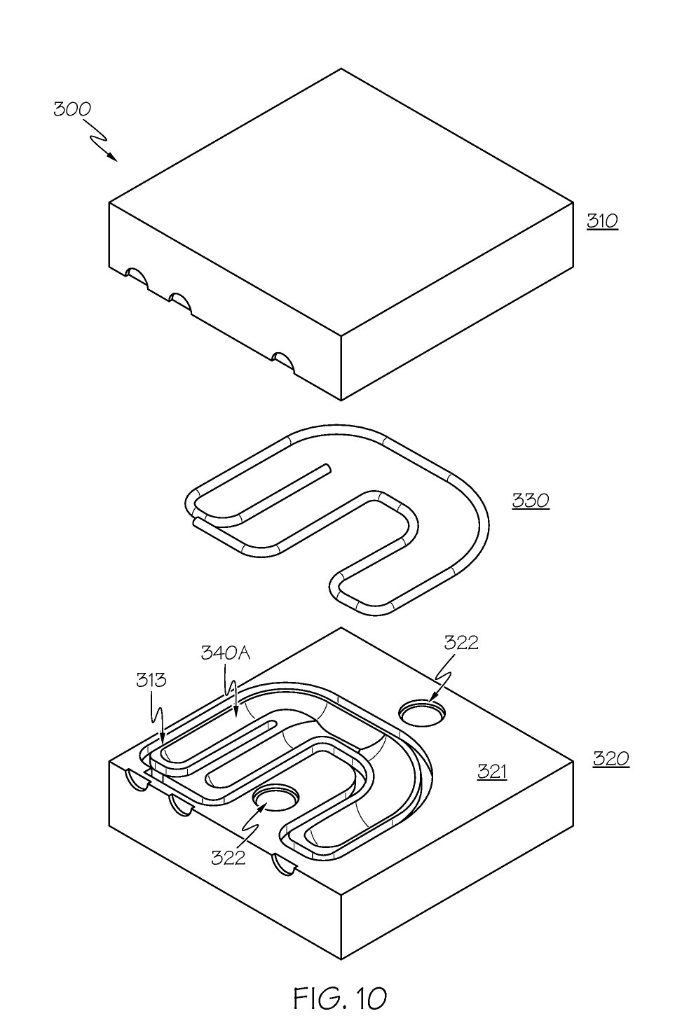

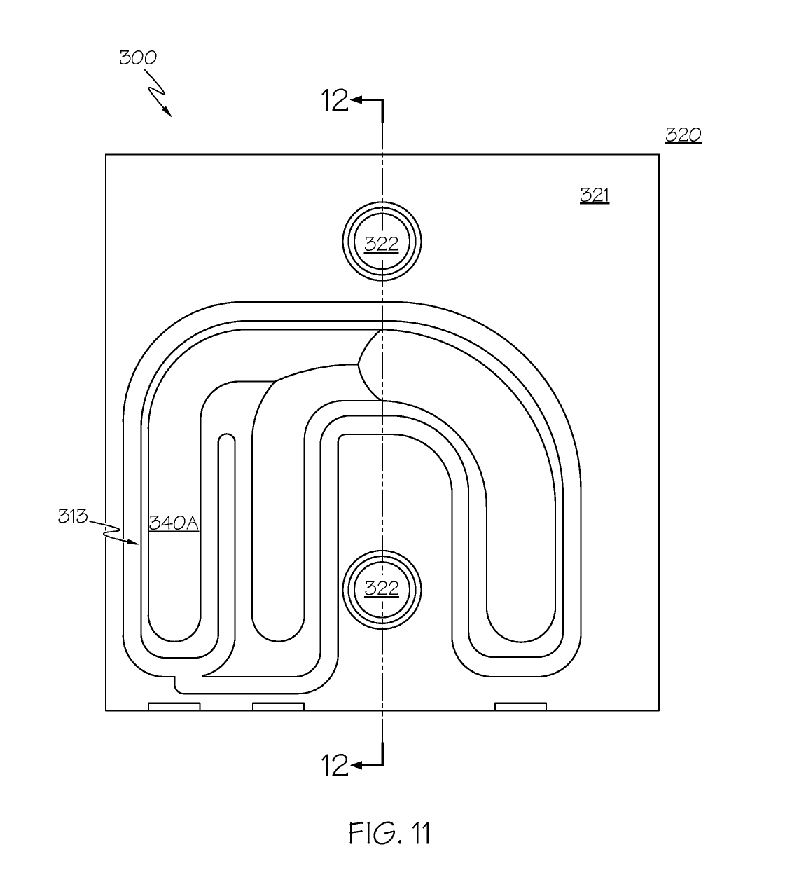

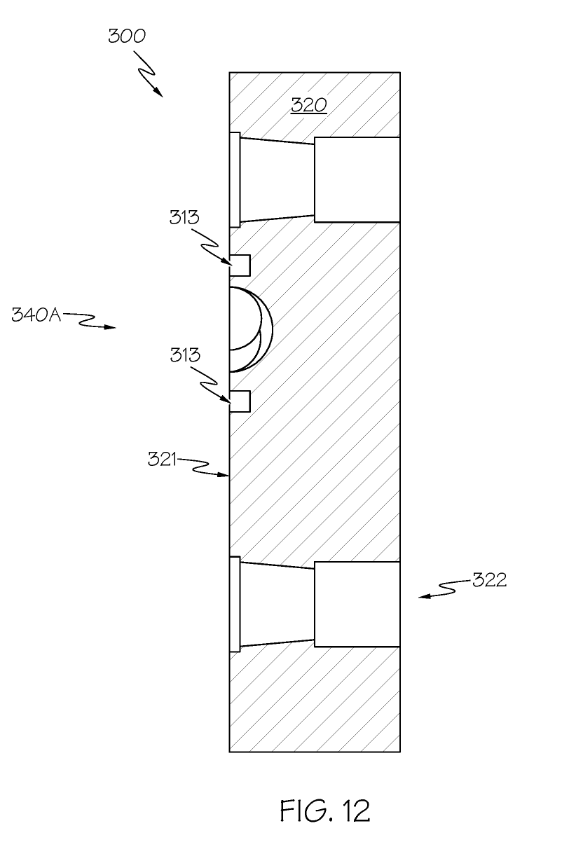

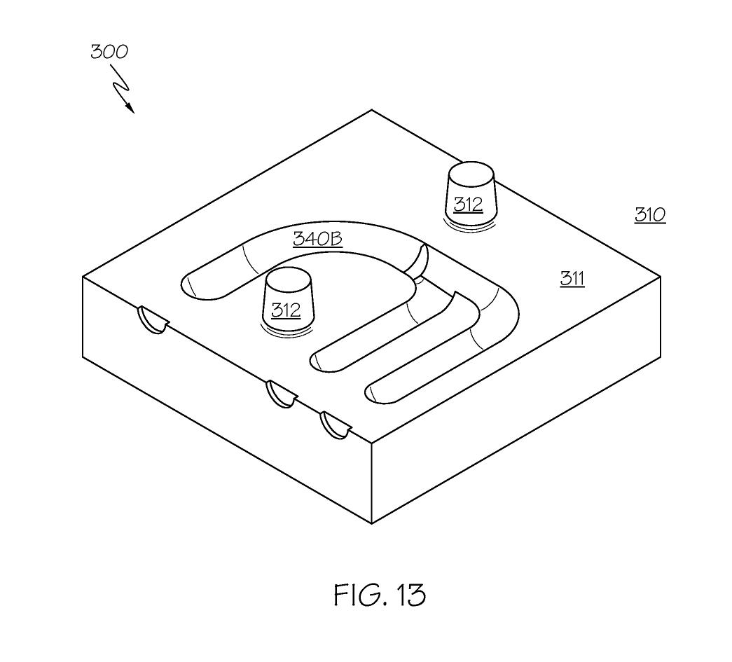

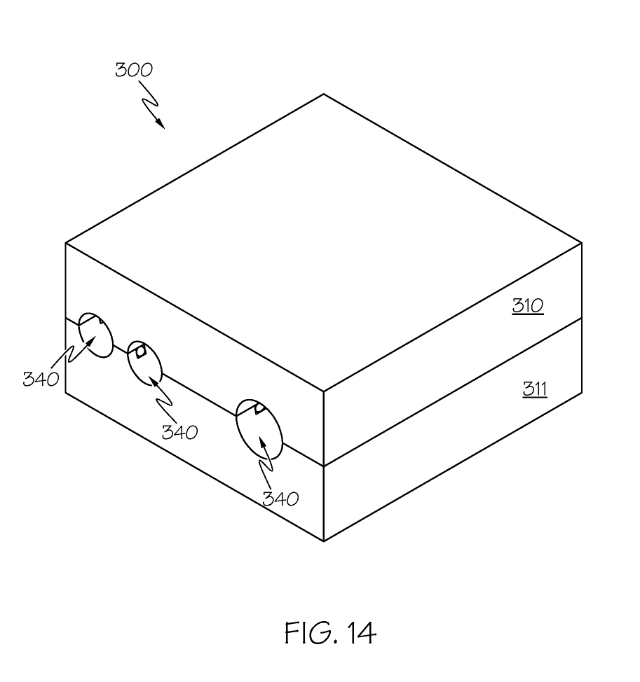

FIG. 10 illustrates an exploded top perspective view of a device 300 for flowing fluids therethrough, including a first structure 310, a second structure 320, and a sealing member 330. FIG. 11 illustrates a top plan view of the second structure 320 of FIG. 10. FIG. 12, illustrates a sectional side view of the second structure 320 along line 12-12 of FIG. 11. FIG. 13 illustrates a perspective view of an underside of the first structure 310 of FIG. 10. FIG. 14 illustrates the first structure 310, the second structure 320, and the sealing member 330 after bonding the first structure 310 and the second structure 320.

As shown, the device 300 for flowing fluids therethrough includes the first structure 310 having a first major side 311, the second structure 320 having a second major side 321, and the sealing member 330.

The first major side 311 of the first structure 310 and the second major side 321 of the second structure 320 together define a plurality of fluid channel surfaces 340A and 340B at an interface of said first major side 311 and said second major side 321 for flowing fluids through a fluid channel of the device.

As further shown, the first major side 311 of the first structure 310 includes a plurality of welding pins 312, and the second major side 321 of the second structure 320 includes a plurality of welding recesses 322. It will be understood that the positions of the welding pin 312 and welding recess 322 may be reversed, such that the second major side 321 of the second structure 320 includes the welding pin 312, and the first major side 311 of the first structure 310 includes the welding recess 322, or such that the second major side 321 of the second structure 320 includes one welding pin and one welding recess and the first major side 311 of the first structure 310 includes another welding pin and another welding recess.

As shown, the first structure 310 and second structure 320 are bonded together by an interference pin weld between the welding pins 312 and the welding recesses 322 creating a metallurgical bond affixing together the first structure 310 and the second structure 320 localized at the connections of the welding pins 312 and welding recesses 322. Due to localized welding of the first structure 310 and the second structure 320, other portions of the first major side 311 and second major side 321 remain unmelted. Therefore, the fluid channel 340 formed at the interface of the first major side 311 and the second major side 321 are not affected by the welding process. Therefore, the structures of the fluid channels 340 are preserved during the bonding of the first structure 310 and the second structure 320, and the fluid channels 340 do not may become partially or fully blocked due to melting and adjacent fluid channels do not become connected due to a breakdown of a barrier therebetween. This preservation of the structures of the fluid channels 340 permits for smaller fluid channels and concentration of multiple adjacent fluid channels with reduced concern that the process of bonding together the first structure and the second structure will unintentionally block a fluid channel or break down a barrier between adjacent fluid channels.

Furthermore, the device 300 provides for sealing of the fluid channels or sealing between adjacent fluid channels. In particular, the first major side 311 of the first structure 310 includes a sealing channel 313 for retaining sealing member 330 therein.

As illustrated, the sealing channel 313 is positioned along one side of the fluid channels 340. However, sealing channel 313 can be arranged in any number of positions to provide a desired sealing effect.

Additionally, it will be understood that the position of sealing channel 313 may be reversed, such the second major side 321 of the second structure 320 includes the sealing channel 313.

The sealing member 330 is formed of a material that is softer than that of the first structure 310 and the second structure 320. Preferably, the sealing member 330 is formed of a metal that is softer (i.e. lower hardness) than that of the first structure 310 and the second structure 320. When the first structure 310 and second structure 320 are bonded together, the sealing member 330 is compressed therebetween to thereby seal the fluid channels 340 or seal between adjacent fluid channels 340.

As shown in FIG. 14, the fluid channels 340 may be externally connected by, for example, drilling connecting holes to connect to fluid channels 340.

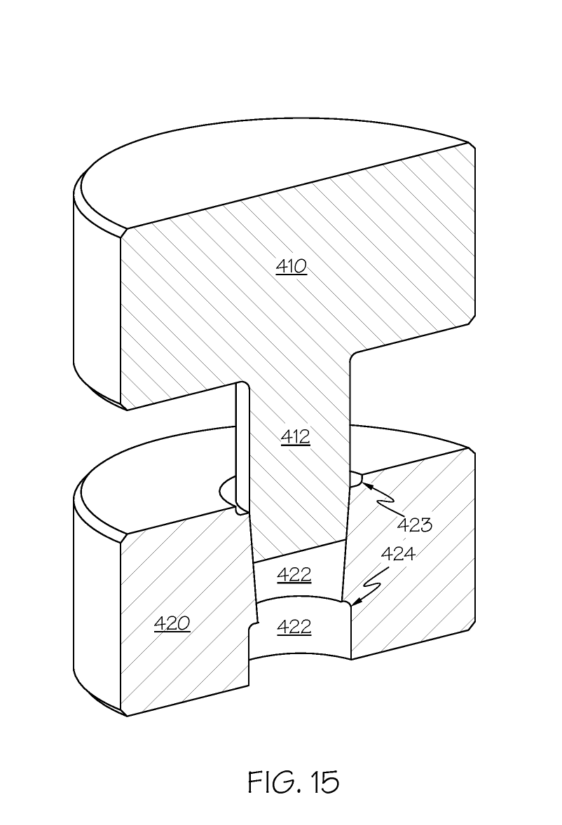

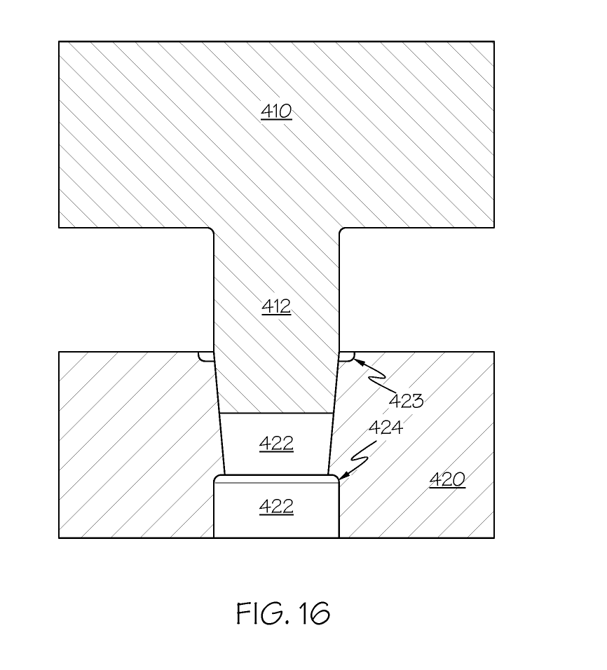

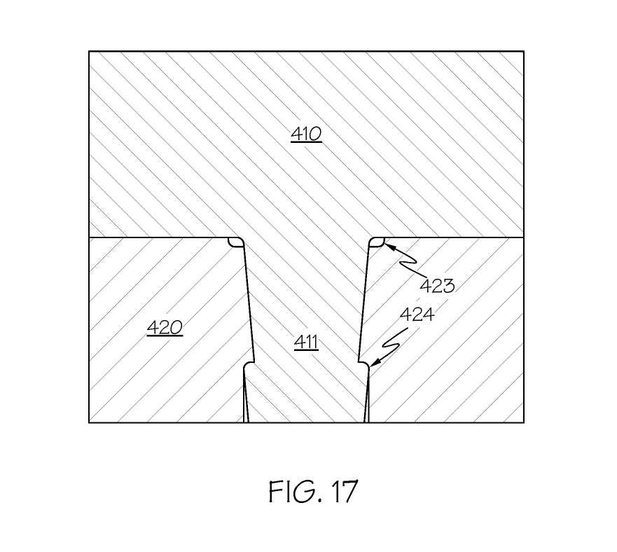

FIGS. 15 and 16 illustrate sectional views an exemplary interference pin welding between a first structure 410 and a second structure 420 prior to welding, and FIG. 17 illustrates a sectional view of the exemplary interference pin welding between the first structure 410 and the second structure 420 after welding.

As shown by FIGS. 15 and 16, the first structure 410 includes a welding pin 412, and the second structure includes a welding recess 422. To facilitate entry of the welding pin 412 into the welding recess 422, the welding pin 412 includes a lower tapered portion having a size that is smaller than a size of an entry portion of the welding recess 422. Alternatively, the welding pin 412 may be untapered, and the welding recess may include an enlarged entry portion having a size larger than the lower portion of the welding pin 412, to facilitate entry of the welding pin 412 into the welding recess 422.

As further shown by FIGS. 15 and 16, entry of the welding pin 412 into the welding recess 422 is stopped by an enlarged shape of the welding pin 412. Thus, there is an inference between the welding pin 412 and the welding recess 422. In an alternative embodiment, entry of the welding pin 412 into the welding recess 422 may stopped by a reduced shape of the welding recess 422.

The welding pin 412 and welding recess 422 are welded together by resistance welding. Thus, an electric current is applied between the first structure 410 and the second structure 420, and the current is focused to the contact of the welding pin 412 and welding recess 422. Meanwhile, a compressive force is applied between the first structure 410 and the second structure. The compressive force effects a frictional force between the welding pin 412 and the welding recess 422 to remove surface oxides or other surface materials, thereby providing for electrical connection between the welding pin 412 and the welding recess 422.

The electric current then heats and melts the welding pin 412 and the welding recess 422 by resistance heating. Meanwhile, the compressive force moves the first structure 410 and the second structure 420 together until the first major surface of the first structure 410 and the second major surface of the second structure 420 are contacted together. Once the first major surface of the first structure and the second major surface of the second structure are contacted, then current applied between the first structure 410 and the second structure 420 is no longer focused to the contact between the welding pin 412 and the welding recess 422, which are then thereby permitted to cool and solidify as a welded region.

As further shown by FIGS. 15-17, the second structure 420 preferably includes welding spillover regions 423 and 424 for accommodating molten material produced and flowed during the welding process.

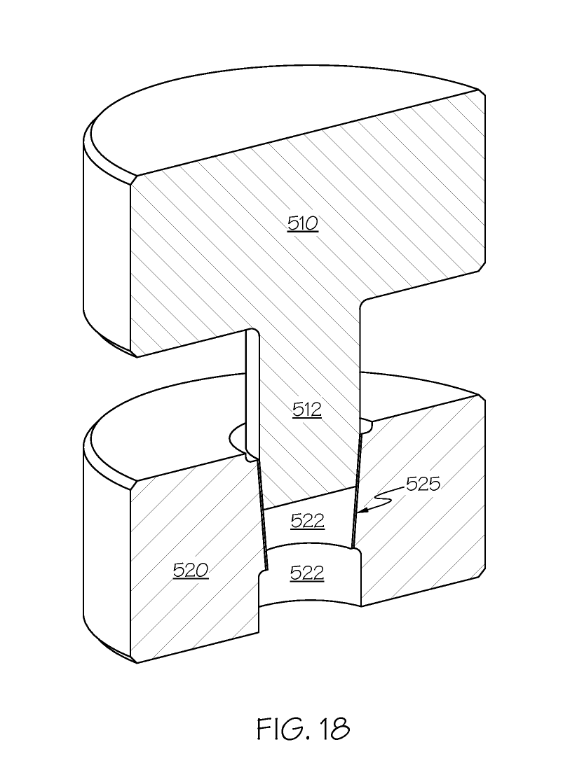

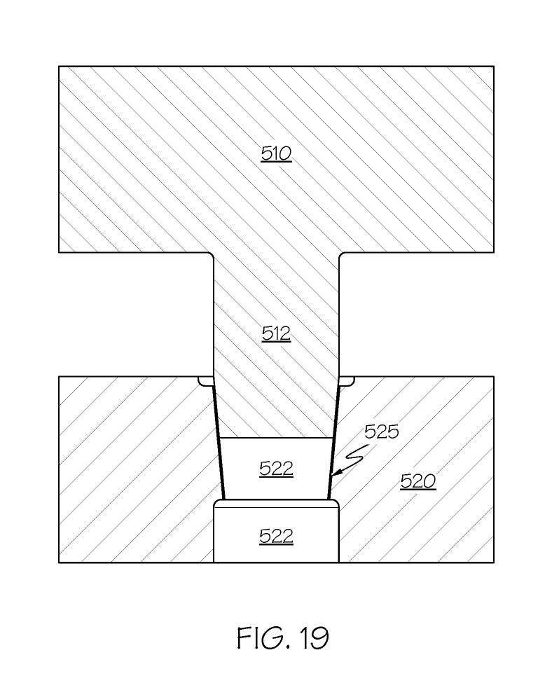

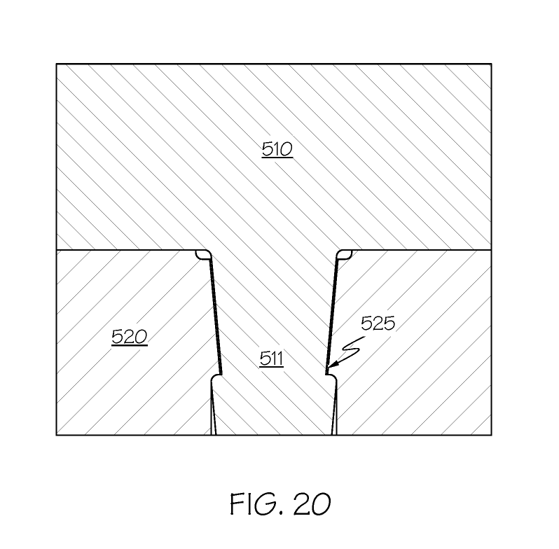

FIGS. 18 and 19 illustrate sectional views another exemplary interference pin welding between a first structure 510 and a second structure 520 prior to welding, and FIG. 20 illustrates a sectional view of the exemplary interference pin welding between the first structure 510 and the second structure 520 after welding.

In comparison to the interference pin welding of FIGS. 15-17, the interference pin welding of FIGS. 18-20 further includes a welding interlayer provided on a surface of the welding recess. For example, the welding interlayer may be spot welded or otherwise bonded to the surface of the welding recess. In an alternative embodiment, position of the welding interlayer may be reversed such that the welding interlayer is on a surface of the welding pin.

As shown by FIGS. 18 and 19, the first structure 510 includes a welding pin 512, and the second structure includes a welding recess 522 having a welding interlayer 525 thereon. To facilitate entry of the welding pin 512 into the welding recess 522, the welding pin 512 includes a lower tapered portion having a size that is smaller than a size of an entry portion of the welding recess 522. Alternatively, the welding pin 512 may be untapered, and the welding recess may include an enlarged entry portion having a size larger than the lower portion of the welding pin 512, to facilitate entry of the welding pin 512 into the welding recess 522.

As further shown by FIGS. 18 and 19, entry of the welding pin 512 into the welding recess 522 is stopped by an enlarged shape of the welding pin 512. Thus, there is an inference between the welding pin 512 and the welding recess 522. In an alternative embodiment, entry of the welding pin 512 into the welding recess 522 may stopped by a reduced shape of the welding recess 522.

The welding pin 512 and welding recess 522 are welded together by resistance welding. Thus, an electric current is applied between the first structure 510 and the second structure 520, and the current is focused to the contact of the welding pin 512 and welding recess 522. Meanwhile, a compressive force is applied between the first structure 510 and the second structure. The compressive force effects a frictional force between the welding pin 512 and the welding recess 522 to remove surface oxides or other surface materials, thereby providing for electrical connection between the welding pin 512 and the welding recess 522.

The electric current then heats and melts the welding pin 512, the welding interlayer 525, and the welding recess 522 by resistance heating. Meanwhile, the compressive force moves the first structure 510 and the second structure 520 together until the first major surface of the first structure 510 and the second major surface of the second structure 520 are contacted together. Once the first major surface of the first structure and the second major surface of the second structure are contacted, then current applied between the first structure 510 and the second structure 520 is no longer focused to the contact between the welding pin 512 and the welding recess 522, which are then thereby permitted to cool and solidify as a welded region.

By including the welding interlayer 525 between the welding pin 512 and the welding recess 522, a first welded region may be formed between the welding interlayer 525 and the welding pin 512 and a second welded region may be formed between the welding interlayer 525 and the welding recess 522. Due to the absence of welding between a first metal composition of the first structure and a second metal composition of the second structure, the first metal composition and second metal composition may be selected from chemistries that are incompatible for welding with each other.

In an alternative embodiment, the welding interlayer may be deposited on one of the welding pin and the welding recess prior to welding such a metallurgical bond is created therebetween prior to welding with the other of the welding pin and welding recess.

As further shown by FIGS. 18-20, the second structure 520 preferably includes welding spillover regions 523 and 524 for accommodating molten material produced and flowed during the welding process.

According to the present description, the first structure may be formed from a first metal composition, and the second structure may be formed from a second metal composition different from said first metal composition. Thus, the present description is capable of providing a device for flowing fluids therethrough, which has a first structure formed from a first metal composition bonded to a second structure formed from a second metal composition with at least one fluid channel at an interface thereof, in which the first and second metal compositions may not have compatible chemistries for welding and in which one or both of the first and metal compositions may have a low melting point such that brazing becomes problematic. For example, in a preferred embodiment, one of said first metal composition and said second metal composition is alloy suitable for high-temperatures, such as a nickel-based alloy, and the other of said first metal composition and said second metal composition is high conductivity, low temperature metal or alloy, such as copper or a copper-based alloy.

It will be understood that above detailed description discloses the invention with reference to bonding the first structure to the second structure by welding, but the invention is equally applicable to bonding the first structure to the second structure by brazing. For example, the welding pin may be brazed to the welding recess using a braze filler, and thus the geometries of the present description by be used with braze at welding pin locations. In particular, the welding interlayer of FIGS. 18 to 20 may be of lower melting nature to permit brazing or may be of a higher melting nature to permit welding.

Although various embodiments of the disclosed devices for flowing fluids therethrough and methods for manufacturing thereof have been shown and described, modifications may occur to those skilled in the art upon reading the specification. The present application includes such modifications and is limited only by the scope of the claims.

What is claimed is:

1. A device for flowing fluids therethrough, the device comprising:
a first structure having a first major side, said first structure comprising a first metal composition;
a second structure having a second major side abutting said first major side of said first structure, said second structure comprising a second metal composition;
at least one welded region affixing said first major side of said first structure with said second major side of said second structure;
at least one fluid channel defined at an unwelded interface of said first major side of said first structure and said second major side of said second structure; and
at least one sealing member compressed between said first major side of said first substrate and said second major side of said second substrate, said at least one sealing member comprising a material having a lower hardness than that of said first metal composition and said second metal composition.

2. The device of claim 1 wherein said second metal composition is different from said first metal composition.

3. The device of claim 2 wherein one of said first metal composition and said second metal composition is a nickel-based alloy and the other of said first metal composition and said second metal composition is copper or a copper-based alloy.

4. The device of claim 1 wherein said at least one sealing member comprises a third metal composition having a lower hardness than that of said first metal composition and said second metal composition.

5. The device of claim 1 wherein at least one of said first major side of said first substrate and said second major side of said second substrate includes a sealing channel, and wherein said sealing member is retained in said sealing channel.

6. The device of claim 1 wherein one of said first major side of said first structure and said second major side of said second structure comprises a welding pin, the other of said first major side of said first structure and said second major side of said second structure comprises a welding recess, and said at least one welded region affixes said welding pin with said welding recess.

7. The device of claim 6 further comprising a welding interlayer on one of said welding pin and said welding recess, wherein said at least one welded region includes a first welded region between said welding interlayer and said welding pin and a second welded region between said welding interlayer and said welding recess.

8. The device of claim 7 wherein said welding interlayer comprises a third metal composition different from said first metal composition and said second metal composition.

9. The device of claim 1 further comprising a welding rivet, wherein said at least one welded region includes a first welded region between said welding rivet and said first major side of said first structure and a second welded region between said welding rivet and said second major side of said second structure.

10. The device of claim 9 wherein said welding rivet comprises a third metal composition different from said first metal composition and said second metal composition.

11. A device for flowing fluids therethrough, the device comprising:
a first structure having a first major side, said first structure comprising a first metal composition;
a second structure having a second major side abutting said first major side, said second structure comprising a second metal composition different from said first metal composition;
a plurality of welded regions affixing said first major side of said first structure with said second major side of said second structure;
a plurality of fluid channels defined at unwelded interfaces of said first major side of said first structure and said second major side of said second structure; and
at least one sealing member compressed between said first major side of said first substrate and said second major side of said second substrate, said at least one sealing member sealing between adjacent fluid channels, said at least one sealing member comprising a third metal composition having a lower hardness than that of said first metal composition and said second metal composition.

12. The device of claim 11 wherein at least one of said plurality of welded regions is disposed between adjacent fluid channels.

13. The device of claim 11 wherein one of said first metal composition and said second metal composition is a nickel-based alloy and the other of said first metal composition and said second metal composition is copper or a copper-based alloy.

14. The device of claim 11 wherein at least one of said first major side of said first substrate and said second major side of said second substrate includes a sealing channel, and wherein said sealing member is retained in said sealing channel.

15. A method for manufacturing a device for flowing fluids therethrough, the method comprising:
providing a first structure having a first major side, said first major side defining a first portion of a plurality of fluid channels;
providing a second structure having a second major side, said second major side defining a second portion of said plurality of fluid channels; and
affixing said first major side of said first structure with said second major side of said second structure by at least one interference pin weld.

16. The method of claim 15 further comprising providing a welding interlayer on one of said welding pin and said welding recess prior to said affixing said first major side of said first structure with said second major side of said second structure.

17. The method of claim 15 further comprising inserting a welding rivet through one of said first structure and said second structure prior to said affixing said first major side of said first structure with said second major side of said second structure

18. The method of claim 15 wherein said first structure comprises a first metal composition, wherein said second structure comprises a second metal composition different from said first metal composition.

19. The method of claim 18 wherein one of said first metal composition and said second metal composition is a nickel-based alloy and the other of said first metal composition and said second metal composition is copper or a copper-based alloy.

20. The method of claim 18 wherein said at least one sealing member comprises a third metal composition having a lower hardness than that of said first metal composition and said second metal composition.

21. A device for flowing fluids therethrough, the device comprising:
a first structure having a first major side, said first structure comprising a first metal composition;
a second structure having a second major side abutting said first major side of said first structure, said second structure comprising a second metal composition;
at least one brazed region affixing said first major side of said first structure with said second major side of said second structure, wherein one of said first major side of said first structure and said second major side of said second structure comprises a pin, the other of said first major side of said first structure and said second major side of said second structure comprises a recess, and said at least one brazed region affixes said pin with said recess;
at least one fluid channel defined at an unbrazed interface of said first major side of said first structure and said second major side of said second structure; and
at least one sealing member compressed between said first major side of said first substrate and said second major side of said second substrate, said at least one sealing member comprising a material having a lower hardness than that of said first metal composition and said second metal composition.
